(19) United States
(12) Patent Application Publication
(10) Pub. No.: US 2009/0141792 A1
(43) Pub. Date: Jun. 4, 2009

(54) IMAGE PROCESSING APPARATUS, MOBILE WIRELESS TERMINAL APPARATUS, AND IMAGE DISPLAY METHOD

(75) Inventors: Hirofumi MORI, Koganei-shi (JP); Masami Morimoto, Fuchu-shi (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/323,874

(22) Filed: Nov. 26, 2008

(30) Foreign Application Priority Data
Nov. 30, 2007 (JP) 2007-310603

(51) Int. Cl. H04N 7/12; H04M 1/00

(52) U.S. Cl. 375/240.01; 455/556.1; 375/E07.076

(57) ABSTRACT

An image decoding unit decodes an encoded stream and determines whether an error has occurred in the frame obtained by decoding. An image estimation unit estimates the image quality of the frame on the basis of the occurrence state of an error in the frame, a quantization step QP, a display timing PTS, and the like, and outputs the frame to a simple enlargement processing unit which performs simple image enlargement processing, an enlargement processing unit which performs normal image enlargement processing, or a frame interpolation unit which performs frame interpolation, in accordance with the estimation result, thereby selectively executing image processing.

### CROSS-REFERENCE TO RELATED APPLICATIONS

This application is based upon and claims the benefit of priority from prior Japanese Patent Application No. 2007-310603, filed Nov. 30, 2007, the entire contents of which are incorporated herein by reference.

### BACKGROUND OF THE INVENTION

1. Field of the Invention

The present invention relates to an image processing apparatus which processes an image based on a video signal transmitted by terrestrial digital broadcasting or the like.

2. Description of the Related Art

As is generally known, terrestrial digital broadcasting includes so-called one-segment broadcasting which uses one of 13 segments divided from one channel in addition to high-quality digital broadcasting. Moving image streams in this one-segment broadcasting are used with parameters such as QVGA (320×180), 15 Hz, and 220 kbps, and greatly vary in image quality in a scene with vigorous movement and a still scene. Recently, cellular phones having a display panel with high resolution such as QVGA or more become popular.

When displaying a moving image obtained by one-segment broadcasting on the display panel with high resolution, the cellular phone enlarges the moving image to fill the display panel because it has a resolution higher than the broadcast resolution as described above. There is a technique available for enlarging the moving image to be displayed on the display panel without any distortion (see, for example, Jpn. Pat. Appln. KOKAI Publication No. 2005-339576). There is also a technique available for increasing a frame rate by inserting an interpolation frame, which is generated from two adjacent frames decoded on the decoding side, into the two adjacent frames so as to smooth a movement of the moving image (see, for example, Jpn. Pat. Appln. KOKAI Publication No. 2006-311480).

Either of these techniques for obtaining high-quality videos places a heavy load on a processor because of the computation amount required. This causes a problem in terms of the duration of a battery in a reception terminal such as a cellular phone.

### BRIEF SUMMARY OF THE INVENTION

The present invention has been made to solve the above problem, and has as its object to provide an image processing apparatus, mobile wireless terminal apparatus, and image display method which can reduce battery power consumption by reducing the load imposed on a processor without degrading the substantial quality of videos.

To achieve this object, the present invention is an image processing apparatus. The image processing apparatus comprises a decoder which decodes a received encoded video data and generates moving image data including a plurality of frames, a first image processing unit which enlarges the frame in accordance with a simple enlargement processing, a second image processing unit which enlarges the frame in accordance with an enlargement processing so as to generate a high quality enlarged frame, an estimation unit which estimates image quality of the frame generated by the decoder, and a control unit which causes one of the first image processing unit and the second image processing unit to enlarge the frame in accordance with the image quality estimated by the estimation unit.

Therefore, according to the present invention, since effective image processing can be selectively performed in accordance with the image quality of a decoded frame, there can be provided an image processing apparatus, mobile wireless terminal apparatus, and image display method which can reduce battery power consumption by reducing the load imposed on a processor without degrading the substantial quality of videos.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a mobile wireless terminal apparatus according to an embodiment to which an image processing apparatus according to the present invention is applied;

FIG. 2 is a block diagram showing the arrangement of the control unit of the mobile wireless terminal apparatus shown in FIG. 1;

FIG. 3 is a view for explaining frame interpolation processing by the mobile wireless terminal apparatus shown in FIG. 1; and

FIG. 4 is a flowchart for explaining processing associated with image enlargement by the mobile wireless terminal apparatus shown in FIG. 1.

### DETAILED DESCRIPTION OF THE INVENTION

An embodiment of the present invention will be described below with reference to the accompanying drawings.

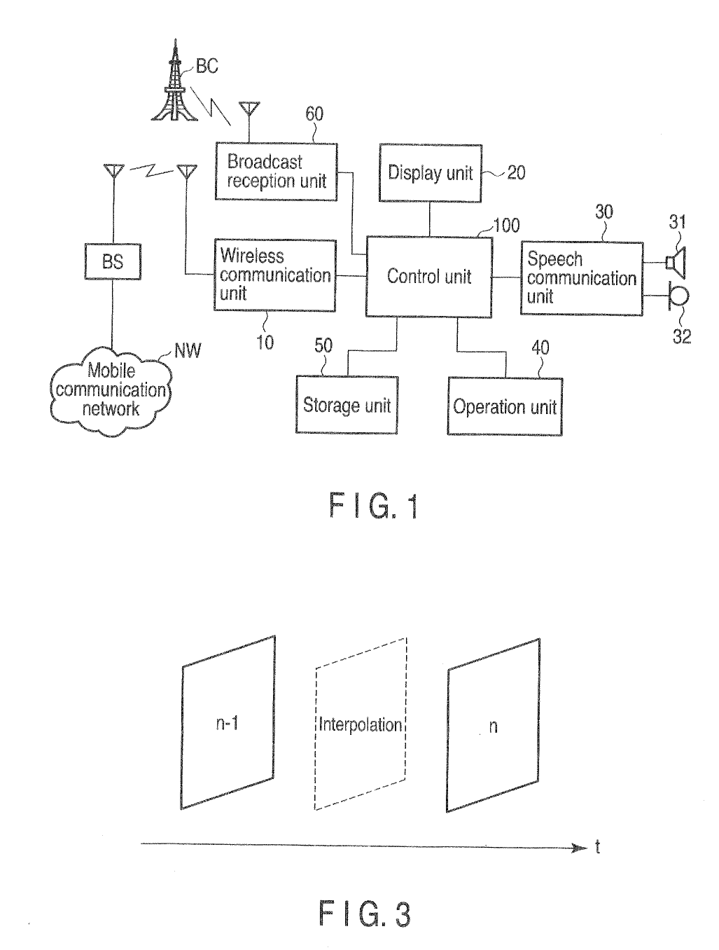

FIG. 1 is a block diagram showing the arrangement of a mobile communication apparatus to which an image processing apparatus according to an embodiment of the present invention is applied. As shown in FIG. 1, this mobile communication apparatus mainly includes a control unit 100, a wireless communication unit 10, a display unit 20, a speech communication unit 30, an operation unit 40, a storage unit 50, and a broadcast reception unit 60. The apparatus has a function of performing communication with another apparatus such as a land phone and a cellular phone via a base station BS and a mobile communication network NW, and has a function of receiving a terrestrial digital broadcast signal transmitted from a broadcasting station BC.

The wireless communication unit 10 performs wireless communication with the base station BS accommodated in the mobile communication network NW, transmission/reception of audio data and electronic mail data, and reception of Web data, streaming data, and the like under the control of the control unit 100.

The display unit 20 displays image (still and moving image etc.), character information, and the like under the control of the control unit 100 so as to visually convey information to the user.

The speech communication unit 30 is connected to a loudspeaker 31 and a microphone 32. The speech communication unit 30 codes the speech, which is input by a user via the microphone 32, into the coded speech data pursuant to a speech coding technology such as an AMR standard and outputs to the control unit 100, and decodes a coded speech from a communication partner and outputs a speech to the loudspeaker 31.

The operation unit 40 includes a plurality of key switches such as alphanumeric keys for inputting digit numbers, alphabets, and characters, and a power key for turning on/off the mobile communication terminal, a plurality of function keys, and the like, and receives an instruction from the user.

The storage unit 50 stores control programs and control data for the control unit 100, application software, address data including the names, telephone numbers, or the like of communication partners, transmitted/received electronic mail data, Web data downloaded by Web browsing, downloaded streaming data, and the like.

The broadcast reception unit 60 receives one segment signal of a terrestrial digital broadcast signal transmitted from the broadcasting station BC, and obtains an encoded video data (video elementary stream) generated by encoding a moving image data in accordance with the H.264 standard or the like and an encoded audio data (audio elementary stream) generated by encoding an audio signal in accordance with the AAC standard or the like. The video elementary stream and the audio elementary stream are in the multiplexed form when they are received by the broadcast reception unit 60.

The control unit 100 includes a microprocessor. The control unit 100 operates in accordance with a control program and control data stored in the storage unit 50, and totally controls the respective units of the mobile communication apparatus to implement speech communication and data communication. The control unit 100 also operates in accordance with application software stored in the storage unit 50 to implement a communication control function of transmitting/receiving electronic mail, performing Web browsing, displaying a moving image on the display unit 20 on the basis of downloaded stream data, and performing speech communication.

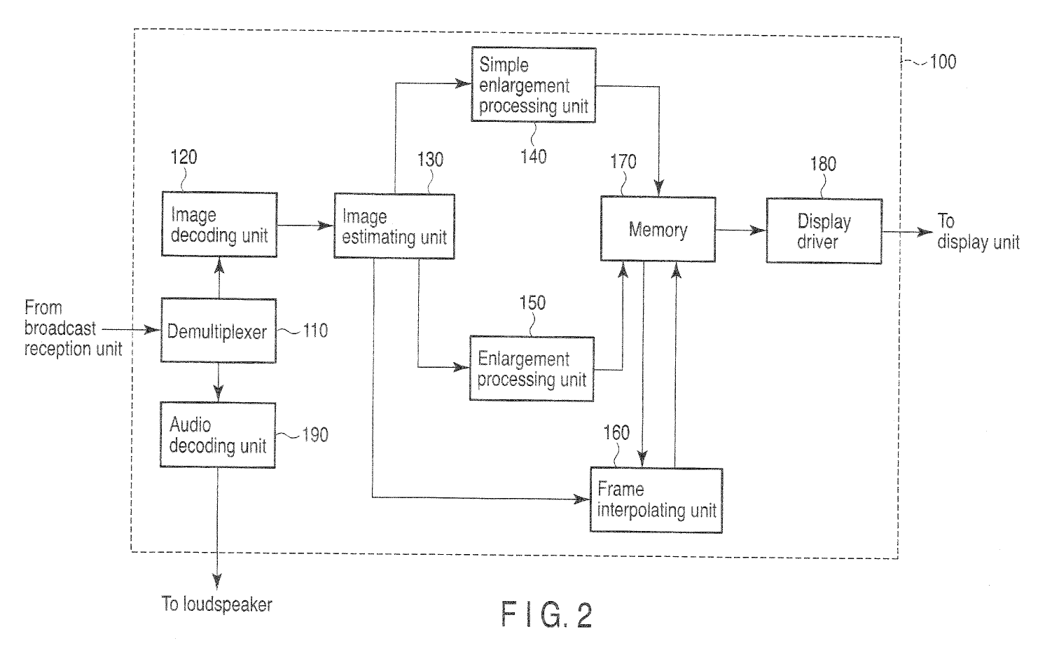

The control unit 100 further has a broadcast reception function of decoding the video elementary stream and the audio elementary stream obtained by the broadcast reception unit 60, and displaying a moving image contained in the decoded broadcast data on the display unit 20 upon performing image processing on the decoded broadcast data. In order to implement this broadcast reception function, as shown in FIG. 2, the control unit 100 includes a demultiplexer unit 110, an image decoding unit 120, an image estimation unit 130, a simple enlargement processing unit 140, an enlargement processing unit 150, a frame interpolation unit 160, a memory 170, a display driver 180, and an audio decoding unit 190. Note that a dedicated loudspeaker (not shown) or the loudspeaker 31 amplifies and outputs the audio signal obtained by the audio decoding unit 190.

The demultiplexer unit 110 demultiplexes the multiplexed video and audio elementary streams received by the broadcast reception unit 60 and the streaming data received by the wireless communication unit 10 into an encoded video data encoded in accordance with the H.264 standard or the like and an encoded audio data encoded in accordance with the AAC standard or the like, and outputs the encoded video data to the image decoding unit 120 and the encoded audio data to the audio decoding unit 190. The image decoding unit 120 extracts a quantization step MBQP for each macro block and a display timing PTS (Presentation Time Stamp) from the encoded video data received from the separation unit 110, and obtains frames forming moving image data by performing decoding processing by using the extracted quantization step MBQP. When a frame is obtained in this manner, the image decoding unit 120 determines whether a frame without any error has been obtained, and also determines that the type of the frame is Instantaneous Decoder Refresh (IDR). Based on these determination results, the image decoding unit 120 then outputs ErrFrmFlag indicating the determination result representing the presence/absence of an error in the frame and Idrflag indicating whether the type of the frame is IDR.

Note that the image decoding unit 120 sets ErrFrmFlag to TRUE when the frame could not be completely decoded because of, for example, the occurrence of an error in the video elementary stream, and sets ErrFrmFlag to FALSE when the frame could be completely decoded. In addition, the image decoding unit 120 sets IdrFlag to TRUE when the type of the frame is IDR, and sets IdrFlag to FALSE when the type is non-IDR.

The image estimation unit 130 estimates the image quality of each frame on the basis of the information obtained by the image decoding unit 120, i.e., ErrFrmFlag and Idrflag described above, selects image processing to be applied to the above decoded image in accordance with the estimation result, and outputs the image data obtained by decoding to one of the simple enlargement processing unit 140 and the enlargement processing unit 150 corresponding to the selected image processing on a frame basis.

The simple enlargement processing unit 140 operates only when the image estimation unit 130 estimates the image quality of image data as “low image quality”, and performs enlargement processing for each frame of image data input from the image estimation unit 130 by filter processing based on matrix computation, thereby enlarging the image size to QVGA or more.

The enlargement processing unit 150 operates only when the image estimation unit 130 estimates the image quality of the frame as “high image quality”, and performs enlargement processing suitable for each frame of image data input from the image estimation unit 130, thereby enlarging the image size to QVGA or more. Note that enlargement processing executed by the enlargement processing unit 150 requires a heavy processing load on the microprocessor of the control unit 100 relative to enlargement processing executed by the simple enlargement processing unit 140.

As shown in FIG. 3, the frame interpolation unit 160 analyzes the correlation between an adjacent frame (n-1) stored in the memory 170 and a current frame (n), and generates an interpolation frame which is expected to exist between the frame (n-1) and the frame (n).

The memory 170 temporarily stores the frame obtained by enlargement processing by the simple enlargement processing unit 140 and the enlargement processing unit 150 and the interpolation frame generated by the frame interpolation unit 160. The display driver 180 reads frames stored in the memory 170.

Even when a frame is read to the display driver 180, the memory 170 holds the frame for a predetermined time period, for example, the time period corresponding to at least the frame rate without immediately erasing the frame, and outputs the stored frame to the frame interpolation unit 160 in accordance with a request from the frame interpolation unit 160.

The display driver 180 reads frames from the memory 170, and drives the display unit 20 to display the frames in accordance with a playback timing, thereby making the display unit 20 display a moving image data.

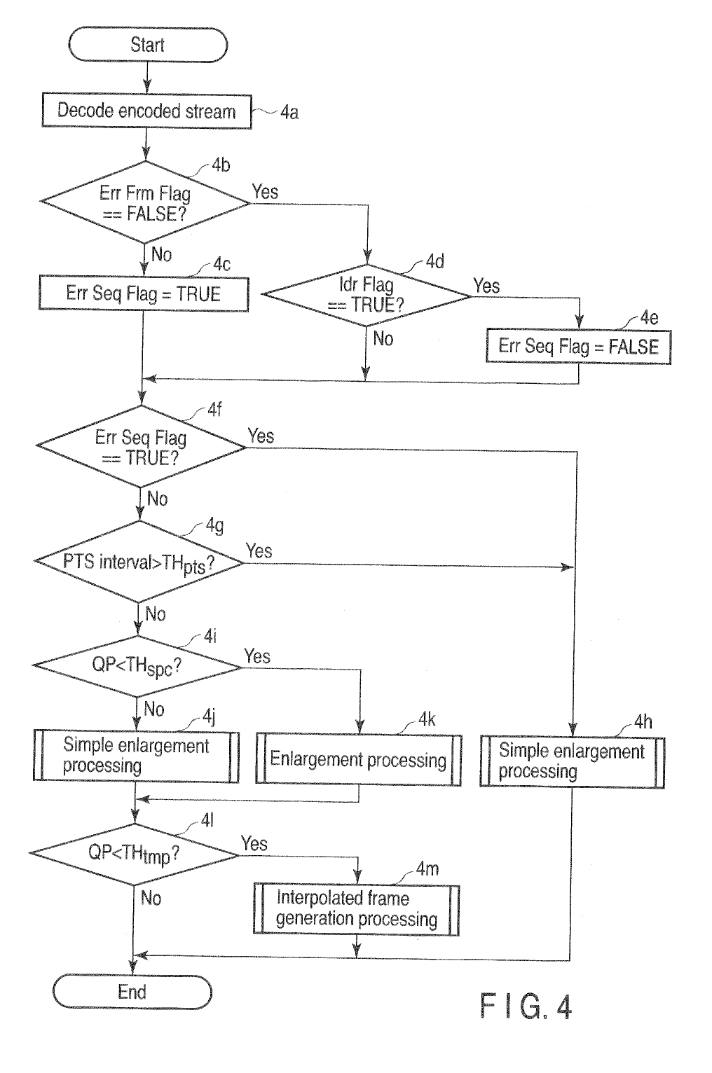

The operation of the mobile communication apparatus having the above arrangement will be described next. Image processing by the control unit 100 will be described in particular below. FIG. 4 is a flowchart showing a control sequence by the control unit 100. At the start of reception of the one segment signal or the streaming data, this sequence is executed for each frame and is repeatedly executed until the reception is complete. The control unit 100 operates in accordance with a control program and control data stored in the storage unit 50 of itself, thereby executing processing in accordance with the control sequence.

In step 4a, the image decoding unit 120 receives and decodes video elementary stream, i.e., the encoded video data in accordance with the H.264 standard, demultiplexed by the demultiplexer unit 110 from the video elementary stream received by the wireless communication unit 10 or the one segment signal received by the broadcast reception unit 60, thereby obtaining moving image data constituted by a plurality of frames. The image decoding unit 120 also extracts the quantization step MBQP and the display timing PTS for each macroblock, which exist in the encoded stream. The image decoding unit 120 also determines whether a frame without any error could be obtained, and also determines whether the type of the frame is IDR. The image decoding unit 120 then generates ErrFrmFlag and IdrFlag on the basis of these determination results, and outputs them to the image estimation unit 130. The process then shifts to step 4b.

In step 4b, the image estimation unit 130 determines the error state of the frame on the basis of ErrFrmFlag supplied from the image decoding unit 120. If ErrFrmFlag indicates FALSE, the process shifts to step 4d. If ErrFrmFlag indicates TRUE, the process shifts to step 4c.

In step 4c, the image estimation unit 130 sets ErrSeqFlag to TRUE because the frame includes an error. The process then shifts to step 4f.

In step 4d, the image estimation unit 130 determines the type of the frame on the basis of IdrFlag supplied from the image decoding unit 120. If IdrFlag indicates TRUE, the process shifts to step 4e. If IdrFlag indicates FALSE, the process shifts to step 4f for the following reason. If IdrFlag is FALSE, i.e., the type of the frame is non-IDR, since there is possibility that a frame including an error was referred to in the past, the process shifts to step 4f without updating ErrSeqFlag even without any error in the frame.

In step 4e, when IdrFlag indicates TRUE, the image estimation unit 130 determines that an IDR frame could be decoded without any error, and sets ErrSeqFlag to FALSE. The process then shifts to step 4f. That is, only when an IDR frame which requires no past frame for decoding can be decoded without any error, ErrSeqFlag is restored to FALSE.

In step 4f, the image estimation unit 130 determines whether ErrSeqFlag is TRUE. If ErrSeqFlag is TRUE, the image estimation unit 130 regards the frame as a frame with low image quality. The process then shifts to step 4h. If ErrSeqFlag is FALSE, the image estimation unit 130 does not regard the frame as a frame with low image quality, and the process shifts to step 4g.

In step 4g, when the frame is decoded without any error, the image estimation unit 130 calculates the PTS interval between frames obtained by decoding, and determines whether the calculated PTS interval is larger than a preset threshold THₚₜₛ. If the PTS interval is larger than the threshold THₚₜₛ, the image estimation unit 130 regards that the frame has low image quality due to an intentional frame skip on the transmitting side or frame loss caused by a transmission error. The process then shifts to step 4h. If the PTS interval is equal to or less than the threshold THₚₜₛ, the image estimation unit 130 does not regard that the frame has low image quality, and the process shifts to step 4i. An intentional frame skip on the transmitting side means that the amount of codes assigned to one frame is increased at the sacrifice of the resolution in the time direction by increasing the interval between encoded frames. That is, a frame in which an intentional frame skip on the transmitting side has occurred can be determined as a frame for which it is difficult to maintain high image quality.

Frame loss caused by the transmission error means that the video elementary stream forming a frame is lost for a predetermined period of time due to a deterioration in the reception state of the video elementary stream, and decoding operation using a frame which should be referred to is not performed. That is, if an error does not occur in a frame, this frame can be determined as a frame with low image quality because there is no proper frame to be referred to due to the frame loss.

In this case, the threshold THₚₜₛ is set by using the mode and average of PTS intervals, e.g., using a value corresponding to 15 fps in one-segment broadcasting as an initial value.

In addition, the user can set the threshold THₚₜₛ with the operation unit 40. If the user wants to give priority to temporal smoothness, he/she sets the threshold THₚₜₛ as a value corresponding to 10 fps or 7.5 fps.

In step 4h, the image estimation unit 130 outputs the frame to the simple enlargement processing unit 140 because the frame is decoded without any error (YES in step 4f) or the frame has low image quality due to a frame skip (YES in step 4g), and terminates the processing.

With this operation, the simple enlargement processing unit 140 executes simple enlargement processing with a light processing load, which is represented by Matrix computation such as Cubic Convolution, to generate an enlarged frame from the original frame, and outputs it to the memory 170. The memory 170 stores the enlarged frame. The display driver 180 then reads the enlarged frame from the memory 170 at the timing based on the display timing PTS, and displays the enlarged frame on the display unit 20.

In step 4i, the image estimation unit 130 estimates the image quality of the frame by comparing an average quantization step QP representing the average of quantization steps MBQP for the respective macroblocks obtained by the image decoding unit 120 with a preset threshold TH_{spc}. In this case, if the average quantization step QP is equal to or more than the threshold TH_{spc}, the image estimation unit 130 determines that the frame is a low-quality frame which is difficult to improve even if enlargement processing requiring a high load is executed. The process then shifts to step 4j. If the average quantization step QP is smaller than the threshold TH_{spc}, the image estimation unit 130 determines that the frame is a high-quality frame requiring heavy-load enlargement processing. The process then shifts to step 4k.

Note that the threshold TH_{spc} used for determination is set by using the average of QP in a frame which appeared in the past, the QP in an IDR frame, and the like as well as permanently using a preset value. The switching of enlargement processing in step 4i can be done on a macroblock basis by determination for each macroblock from a macroblock-basis MBQP instead of determination on a frame basis like that described above. It also suffices to perform the above determination and selection of enlargement processing for each area constituted by a plurality of macroblocks.

In addition, the user can set the threshold TH_{spc} with the operation unit 40. If the user wants to give priority to the image quality of an even low-quality image, he/she decreases the threshold TH_{spc}.

In step 4j, the image estimation unit 130 outputs the decoded image of the frame to the simple enlargement processing unit 140 because the frame is a low-quality frame. The process then shifts to step 4l. With this operation, the simple enlargement processing unit 140 executes simple enlargement processing with a light processing load, which is represented by Matrix computation such as Cubic Convolution, to generate an enlarged frame from the frame, and outputs it to the memory 170. The memory 170 stores the enlarged frame. The display driver 180 then reads the enlarged frame from the memory 170 at the timing based on the display timing PTS, and displays the enlarged frame on the display unit 20.

In step 4k, the image estimation unit 130 outputs the frame to the enlargement processing unit 150 because the frame is a high-quality frame. The process then shifts to step 4l.

With this operation, the enlargement processing unit 150 executes enlargement processing with high sharpness and a heavy processing load as in Jpn. Pat. Appln. KOKAI Publication No. 2005-339576 to generate an enlarged frame from the original frame, and outputs it to the memory 170. Here, there are many available image processing techniques other than the technique described in the Japanese Publication for enlarging a frame to satisfy high-resolution image. One of these techniques can be applied to the enlargement processing unit 150. The memory 170 stores the enlarged frame. The display driver 180 then reads the enlarged frame from the memory 170 at the timing based on the display timing PTS and displays the enlarged frame on the display unit 20.

In step 4l, the image estimation unit 130 estimates the image quality of the frame by comparing the quantization step QP obtained by the image decoding unit 120 with a preset threshold THₜₘₚ. If the quantization step QP is equal to or more than threshold THₜₘₚ, the image estimation unit 130 determines that the frame is a low-quality frame for which frame interpolation is invalid, and terminates the processing. If the quantization step QP is smaller than the threshold THₜₘₚ, the image estimation unit 130 determines that the frame is a high-quality frame for which frame interpolation is valid. The process then shifts to step 4m.

The user can set the threshold THₜₘₚ with the operation unit 40 as in the case with the threshold TH_{spc}.

In step 4m, the image estimation unit 130 outputs the frame to the frame interpolation unit 160 because the frame is a high-quality frame, and terminates the processing.

With this operation, the frame interpolation unit 160 performs the interpolation processing of generating an interpolation frame which is expected to exist between the frame and the adjacent frame on the basis of a plurality of enlarged frames stored in the memory 170 in the past by using a technique like that in Jpn. Pat. Appln. KOKAI Publication No. 2006-311480, and outputs the generated interpolation frame to the memory 170. The memory 170 stores the enlarged frames. The display driver 180 then reads the interpolation frame from the memory 170 at the timing based on the display timing PTS, and displays the interpolation frame on the display unit 20.

Note that the thresholds THₚₜₛ, THₜₘₚ, and TH_{spc} can be set to values corresponding to image quality modes which the user can arbitrarily select with the operation unit 40. If, for example, the user selects a “motion priority” mode, TH_{spc} is set to a value larger than THₜₘₚ. If the user selects a “viewing time priority” mode, TH_{spc} is set to a value larger than THₜₘₚ to reduce the processing load.

As described above, the image processing apparatus having the above arrangement estimates the image quality of a frame obtained by decoding based on the state of occurrence of an error, a frame interval, and a quantization step, and selectively executes enlargement/interpolation processing in accordance with the estimated image quality, thereby limiting heavy-load processing to a scene which can be subjectively improved.

That is, this apparatus executes image processing with a heavy processing load for image quality with which the effect of the processing is high. In contrast, the apparatus does not execute image processing with a heavy processing load for low image quality with which it is difficult to obtain the effect of the processing, and executes image processing with a light processing load for low image quality with which the effect of the processing is sufficiently high. The image processing apparatus having the above arrangement can therefore reduce the load imposed on the processor without degrading the substantial quality of a video or losing any image improving effect.

Note that the present invention is not limited to the above embodiments, and constituent elements can be variously modified and embodied at the execution stage within the spirit and scope of the invention. Various inventions can be formed by proper combinations of a plurality of constituent elements disclosed in the above embodiments. For example, several constituent elements may be omitted from all the constituent elements in each embodiment. In addition, constituent elements of the different embodiments may be combined as needed.

For example, the above embodiment has exemplified the case in which the image processing apparatus according to the present invention is applied to the mobile wireless terminal apparatus. However, the present invention is not limited to this. The present invention can be applied to any apparatus which receives and displays moving image data, and can obtain the same effects as those described above.

In addition, the embodiment can be variously modified and executed within the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a decoder which decodes a received encoded video data and generates moving image data including a plurality of frames;
a first image processing unit which enlarges the frame in accordance with a simple enlargement processing;
a second image processing unit which enlarges the frame in accordance with an enlargement processing so as to generate a high quality enlarged frame;
an estimation unit which estimates image quality of the frame generated by the decoder; and
a control unit which causes one of the first image processing unit and the second image processing unit to enlarge the frame in accordance with the image quality estimated by the estimation unit.

2. The apparatus according to claim 1, wherein the estimation unit comprises,
a detecting unit which detects an error which has occurred in the frame generated by the decoder, and
a determining unit which determines the image quality based on whether the error is occurred in the frame.

3. The apparatus according to claim 1, wherein the estimation unit comprises,
a detecting unit which detects timing information indicating a display timing included in the frame, and
a determining unit which determines the image quality based on time interval between two timing information detected by the detecting unit.

4. The apparatus according to claim 1, wherein the estimation unit comprises,
a computing unit which obtains an average quantization step from quantization steps of macroblocks included in the frame, and
a determining unit which determines the image quality based on the average quantization step detected by the computing unit.

5. The apparatus according to claim 1, further comprising,
a frame interpolation unit which generates, on the basis of a plurality of frames generated by the first image processing unit and the second image processing unit, an interpolation frame to be inserted between the enlarged frames,
wherein the control unit which causes the frame interpolation unit to generate the interpolation frame in accordance with the image quality estimated by the estimation unit.

6. A mobile communication apparatus comprising:
a receiver which receives an encoded video data from a broadcasting apparatus;
a decoder which decodes a received encoded video data and generates moving image data including a plurality of frames;
a first image processing unit which enlarges the frame in accordance with a simple enlargement processing;
a second image processing unit which enlarges the frame in accordance with an enlargement processing so as to generate a high quality enlarged frame;
an estimation unit which estimates image quality of the frame generated by the decoder; and
a control unit which causes one of the first image processing unit and the second image processing unit to enlarge the frame in accordance with the image quality estimated by the estimation unit.

7. The apparatus according to claim 6, wherein the estimation unit comprises,
a detecting unit which detect an error which has occurred in the frame generated by the decoder, and
a determining unit which determines the image quality based on whether the error is occurred in the frame.

8. The apparatus according to claim 6, wherein the estimation unit comprises,
a detecting unit which detects timing information indicating a display timing included in the frame, and
a determining unit which determines the image quality based on time interval between two timing information detected by the detecting unit.

9. The apparatus according to claim 6, wherein the estimation unit comprises,
a computing unit which obtains an average quantization step from quantization steps of macroblocks included in the frame, and
a determining unit which determines the image quality based on the average quantization step detected by the computing unit.

10. The apparatus according to claim 6, further comprising,
a frame interpolation unit which generates, on the basis of a plurality of frames generated by the first image processing unit and the second image processing unit, an interpolation frame to be inserted between the enlarged frames,
wherein the control unit which causes the frame interpolation unit to generate the interpolation frame in accordance with the image quality estimated by the estimation unit.

11. An image display method comprising:
a decoding step of decoding a received encoded video data and generates moving image data including a plurality of frames;
a first image processing step of enlarging the frame in accordance with a simple enlargement processing;
a second image processing step of enlarging the frame in accordance with an enlargement processing so as to generate a high quality enlarged frame;
an estimation step of estimating image quality of the frame generated by the decoding step; and
a control step of causing one of the first image processing step and the second image processing step to enlarge the frame in accordance with the image quality estimated in the estimation step.

12. The method according to claim 11, wherein the estimation step comprises,
a detecting step of detecting an error which has occurred in the frame generated by the decoder, and
a determining step of determining the image quality based on whether the error is occurred in the frame.

13. The method according to claim 11, wherein the estimation step comprises,
a detecting step of detecting timing information indicating a display timing included in the frame, and
a determining step of determining the image quality based on time interval between two timing information detected in the detecting step.

14. The method according to claim 11, wherein the estimation step comprises,
a computing step of obtaining an average quantization step from quantization steps of macroblocks included in the frame, and
a determining step of determining the image quality based on the average quantization step detected in the computing step.

15. The method according to claim 11, further comprising,
a frame interpolation step of generating, on the basis of a plurality of frames generated by the first image processing unit and the second image processing unit, an interpolation frame to be inserted between the enlarged frames,
wherein the control step of causing the frame interpolation step to generate the interpolation frame in accordance with the image quality estimated in the estimation step.
